(19) United States
(12) Patent Application Publication
(10) Pub. No.: US 2013/0163879 A1
(43) Pub. Date: Jun. 27, 2013

(54) METHOD AND SYSTEM FOR EXTRACTING THREE-DIMENSIONAL INFORMATION

(71) Applicants: Barak Katz, Ashkelon (IL); Oded Zahavi, Modiln (IL)

(72) Inventors: Barak Katz, Ashkelon (IL); Oded Zahavi, Modiln (IL)

(73) Assignee: BK-Imaging Ltd., Ashkelon (IL)

(21) Appl. No.: 13/819,747

(22) PCT Filed: Aug. 29, 2011
(86) PCT No.: PCT/IL11/00691

§ 371 Date: Feb. 28, 2013

Related U.S. Application Data
(60) Provisional application No. 61/402,404, filed on Aug. 30, 2010.
(60) Provisional application No. 61/462,997, filed on Feb. 11, 2011.
(60) Provisional application No. 61/520,384, filed on Jun. 10, 2011.
(60) Provisional application No. 61/571,919, filed on Jul. 8, 2011.

(51) Int. Cl. G06K 9/62

(52) U.S. Cl. CPC G06K 9/6202
USPC 382/195

(57) ABSTRACT

A method of extracting three-dimensional (3D) information from an image of a scene is disclosed. The method comprises: comparing the image with a reference image associated with a reference depth map, so as to identify an occluded region in the scene; analyzing an extent of the occluded region; and based on the extent of the occluded region, extracting 3D information pertaining to an object that occludes the occluded region. In some embodiments the 3D information is extracted, based, at least in part, on parameters of the imaging system that acquires the image.

### RELATED APPLICATIONS

This application claims the benefit of priority from U.S. Application Nos. 61/402,404 filed on Aug. 30, 2010, 61/462,997 filed on Feb. 11, 2011, 61/520,384 filed on Jun. 10, 2011 and 61/571,919 filed on Jul. 8, 2011.

The contents of all of the above documents are incorporated by reference as if fully set forth herein.

### FIELD AND BACKGROUND OF THE INVENTION

The present invention, in some embodiments thereof, relates to image analysis and, more particularly, but not exclusively, to method and system for extracting three-dimensional information by image analysis.

Tracking articulated human motion is of interest in numerous applications including video surveillance, gesture analysis, human computer interface, video content retrieval and computer animation. For example, in creating a sports video game it may be desirable to track the three-dimensional (3D) motions of an athlete in order to realistically animate the game's characters. In biomedical applications, 3D motion tracking is important in analyzing and solving problems relating to the movement of human joints.

In the past, subjects were required to wear suits with special markers and perform motions recorded by complex 3D capture systems, but modern techniques do not require special clothing or markers. A number of algorithms were proposed to track body motion in the two-dimensional (2D) image plane. Also known are three-dimensional tracking techniques.

One technique, known as confocal imaging, is typically used in optical microscopy. In this technique, a pinhole is placed in the optical setup so as to block defocus light from unwanted planes and to transfer light only from a precisely defined in-focus plane [T. Wilson and B. R. Masters, “Confocal microscopy,” Appl. Opt. 33, 565-566 (1994)]. Also known are techniques that are base on post-processing, e.g., deconvolution [McNally et al., “Three-dimensional imaging by deconvolution microscopy,” Methods, 19, 373-385 (1999)], integral imaging [Hwang et al., “Depth extraction of three-dimensional objects in space by the computational integral imaging reconstruction technique,” Appl. Opt. 47, D128-D135 (2008), and Saavedra et al., “Digital slicing of 3D scenes by Fourier filtering of integral images,” Opt. Express, 16, 17154-17160 (2008)], light field rendering [Levoy et al., “Light field rendering,” Proceedings of the 23rd annual conference on Computer graphics and interactive techniques, p. 31-42 (1996)] and Scanning holography [Indebetouw et al., “Scanning holographic microscopy with spatially incoherent sources: reconciling the holographic advantage with the sectioning advantage,” J. Opt. Soc. Am. A 26, 252-258 (2009)].

Additionally known are 3D tracking optical methods which are based on active illumination and distance measurements, such as laser strip techniques, methods which are based on time of propagation of laser, time-of-light cameras, profile from focus, and structured light imaging [Clark et al., “Measuring range using a triangulation sensor with variable geometry,” IEEE Trans. Rob. Autom. 14, 60-68 (1998); M. D. Adams, “Lidar Design, Use and Calibration Concepts for Correct Environmental Detection”, IEEE Transactions on Robotics and Automation, Vol 16(6), December 2000; Kolb et al., “ToF-Sensors: New Dimensions for Realism and Interactivity,” Proc. IEEE Comp. Soc. Conf. on Computer Vision and Pattern Recognition (CVPR), 1518-1523 (2008); and Loh et al., “Estimation of surface normal of a curved surface using texture,” In Proc. of the 7th Australian Pattern Recognition Society Conference—Digital Image Computing: Techniques and Applications, 155-164 (2003)].

Other techniques include the depth from motion technique [Bolles et al., “Epipolar-plane image analysis: An approach to determining structure from motion,” International Journal of Computer Vision 1(1): 7-55 (1987)] which is used in the computer vision community, and the stereoscopic depth estimation method in which a map of depths is obtained using the triangulation and epipolar geometry principles [Trucco et al., “Introductory techniques for 3D computer vision,” Prentice Hall, 140-143 (1998)].

Additional background art includes Bo Wu and Nevatia R., Detection of Multiple Partially Occluded Humans in a Single Image by Bayesian Combination of Edgelet Part Detectors. In 10th IEEE International Conference on Computer Vision, ICCV'05, Volume 1, Pages 90-97, 2005; Saad M. Khan and Mubarak Shah, A Multiview Approach to Tracking People in Crowded Scenes using a Planar Homography Constraint. In IEEE International Conference on Computer Vision, ECCV'06, Volume 3954, Pages 133-146, 2006; Cheriyadat, A. M., Bhaduri B. L. and Radke R. J., Detecting multiple moving objects in crowded environments with coherent motion regions. in IEEE Computer Society Conference, Pages: 1-8, 2008; Marchand et al., Robust real-time visual tracking using a 2D-3D model-based approach. In Proc. Of the 7th IEEE International Conference on Computer Vision, ICCV'99, Volume 1, Pages 262-268, Kerkira, Greece, September 1999; U.S. Published Application No. 2010014781; and U.S. Published Application No. 2011090318.

### SUMMARY OF THE INVENTION

According to an aspect of some embodiments of the present invention there is provided a method of extracting three-dimensional information from an image, of a scene. The method comprises: comparing the image with a reference image associated with a reference depth map, so as to identify an occluded region in the scene; analyzing an extent of the occluded region; and based on the extent, extracting at least one of: a three-dimensional size and a three-dimensional location of an object occluding the occluded region.

According to some embodiments of the invention the method comprises receiving information pertaining to the height of the object, wherein the extraction of the three-dimensional location utilizes a single viewpoint vector and is based on the height.

According to some embodiments of the invention the method comprises receiving a plurality of images and a plurality of reference images, respectively corresponding to a plurality of viewpoints of the same scene, wherein the comparison and the extent analysis is performed separately for each image, and wherein the extraction is based on relations between the extents.

According to some embodiments of the invention the method comprises receiving information pertaining to the height of the object, wherein the extraction of the three-dimensional location is also based on the height.

According to some embodiments of the invention the extraction comprises calculating the coordinates of a point of intersection between the projection of two viewpoint vectors on a plane of the reference depth map.

According to some embodiments of the invention the extraction comprises calculating the coordinates of a line of intersection between two planes each being defined by a respective viewpoint vector and a projection of the respective viewpoint vector on a plane of the reference depth map.

According to some embodiments of the invention the method comprises comparing a size of the object as extracted based on one viewpoint vector with a size of the object as extracted based on another viewpoint vector, and using the comparison for defining a weight, wherein the extracting of the three-dimensional location is partially based on the weight.

According to some embodiments of the invention the image is a video stream defined over a plurality of frames, and wherein the comparison, the analysis and the extraction are performed separately for each of at least some of the frames.

According to some embodiments of the invention the video stream is captured by at least one moving video camera, and the method further comprises correcting the image based on a motion path of the video camera.

According to some embodiments of the invention the method comprises segmenting the image, wherein the identification of the occluded region is based, at least in part, on the segmentation.

According to some embodiments of the invention the method comprises communicating the size and/or location to a controller of a time-of-flight camera and using the size and/or location for correcting wraparound errors of the camera.

According to some embodiments of the invention the method comprises acquiring the image.

According to some embodiments of the invention the method comprises acquiring the reference image.

According to some embodiments of the invention the method comprises associating the reference image with the reference depth map.

According to some embodiments of the invention the associating is by range imaging.

According to an aspect of some embodiments of the present invention there is provided a method of three-dimensional tracking. The method comprises: acquiring at least one video stream defined over a plurality of frames from a scene including therein a moving object; for each of at least some of the frames, executing the method as described above so as to extract three-dimensional location of the object, thereby providing a set of locations; and using the set of locations for tracking the object.

According to some embodiments of the invention the method comprises predicting future motion of the object based on the tracking.

According to some embodiments of the invention the method comprises identifying or predicting abrupt change of altitude during the motion of the object, and issuing an alert responsively to the identification.

According to some embodiments of the invention the moving object is a human or animal.

According to some embodiments of the invention the method comprises adjusting artificial environmental conditions based on the tracking.

According to some embodiments of the invention the method comprises identifying or predicting a change of posture of the object, and issuing an alert responsively to the identification.

According to some embodiments of the invention the moving object is a ground vehicle.

According to some embodiments of the invention the moving object is a sea vessel.

According to some embodiments of the invention the moving object is an airborne vehicle.

According to some embodiments of the invention the scene includes a plurality of objects, wherein the tracking is executed for each of at least some of the plurality of objects.

According to some embodiments of the invention the method comprises counting the objects.

According to some embodiments of the invention the method comprises transmitting information pertaining to the tracking to the object.

According to some embodiments of the invention the method comprises transmitting information pertaining to the tracking to a nearby object in the scene.

According to some embodiments of the invention the transmitting the information via a hotspot access point being in communication with the respective object.

According to some embodiments of the invention the method comprises identifying the object.

According to some embodiments of the invention the method comprises issuing an alert when the object enters a predetermined region.

According to some embodiments of the invention the method comprises issuing an alert when a motion characteristic satisfies a predetermined criterion.

According to an aspect of some embodiments of the present invention there is provided a computer software product, comprising a computer-readable medium in which program instructions are stored, which instructions, when read by a computer, cause the computer to receive an image and a reference image, and to execute the method as described above.

According to an aspect of some embodiments of the present invention there is provided a system for extracting three-dimensional information. The system comprises at least one image capturing system; and a data processor configured for receiving at least one image of a scene from the at least one image capturing system, accessing at least one recorded reference image associated with a reference depth map, comparing the at least one image with the at least one reference image to identify an occluded region in the scene, analyzing an extent of the occluded region, and extracting at least one of: a three-dimensional size and a three-dimensional location of an object occluding the occluded region, based on the extent.

According to some embodiments of the invention the system is a component in a time-of-flight imaging system.

According to some embodiments of the invention the system is mountable on a vehicle such that the scene regions outside said vehicle, wherein the data processor is configured for tracking motion of objects nearby the vehicle.

According to some embodiments of the invention the at least one image capturing system is mounted indoor, and wherein the data processor is configured for transmitting information pertaining to the location and/or size via a hotspot access point.

According to an aspect of some embodiments of the present invention there is provided an indoor positioning system, comprising the system as described above.

According to an aspect of some embodiments of the present invention there is provided a vehicle imaging system, comprising the system as described above.

According to an aspect of some embodiments of the present invention there is provided a traffic control system, comprising the system as described above.

According to an aspect of some embodiments of the present invention there is provided an air traffic control system, comprising the system as described above.

According to an aspect of some embodiments of the present invention there is provided an artificial environment control system, comprising the system as described above.

According to an aspect of some embodiments of the present invention there is provided an interactive computer game system, comprising the system as described above.

According to an aspect of some embodiments of the present invention there is provided a method of monitoring. The method comprises: analyzing a video stream of a subject so as to identify a posture of the subject; comparing the posture with a database of postures which are specific to the subject; based on the comparison, determining the likelihood that the subject is at risk of falling; and issuing an alert if the likelihood is above a predetermined threshold.

According to some embodiments of the invention the method comprises communicating with at least one risk monitoring device, wherein the determining the likelihood is based also on data received from the risk monitoring device.

According to some embodiments of the invention the method comprises: communicating with at least one wearable risk monitoring device; determining whether the device is worn and/or being activate; and issuing an alert, if the device is not worn or not activate.

According to an aspect of some embodiments of the present invention there is provided a method of identifying a subject. The method comprises: analyzing a video stream of a scene having a plurality of subjects therein so as to extract three-dimensional information pertaining to locations, shapes and sizes of the subjects; dynamically receiving from a cellular positioning system subject-identification codes for uniquely identifying the subjects at the scene; monitoring changes in the three-dimensional locations, so as relate, for at least one subject in the scene, a subject-identification code to a three-dimensional shape and size; and making a record of the relation.

According to an aspect of some embodiments of the present invention there is provided a visual communication system. The system comprises: at least one access point or beacon, configured for broadcasting data over a communication region; an arrangement of imaging devices deployed over the communication region; and a data processor configured for receiving images from the imaging devices, determining three-dimensional information pertaining to individuals in the images, and broadcasting the three-dimensional information using the at least one access point or beacon such that at least one individual in the region receives a location and visualization of at least one tracked individual in the region.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings and images. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart diagram of a method suitable for extracting three-dimensional information from an image according to various exemplary embodiments of the present invention;

FIGS. 2A-B are schematic illustrations of a platform (FIG. 2A) that can be used for constructing a 3D coordinate system (FIG. 2B);

FIG. 3 is a schematic illustration of a procedure suitable for extracting 3D information using a single viewpoint, according to some embodiments of the present invention;

FIGS. 4A-C are schematic illustrations of procedures suitable for extracting 3D information using two or more viewpoints, according to some embodiments of the present invention;

FIG. 5 is a schematic illustration of a system for extracting three-dimensional information, in various exemplary embodiments of the invention;

FIGS. 6A-F shows an experimental procedure used according to some embodiments of the present invention, for extracting 3D information when the point of contact between the objects and the ground are resolvable;

FIGS. 7A-D show an experimental procedure used according to some embodiments of the present invention for extracting 3D information by analyzing points which are above ground level;

FIGS. 8A-F show results of an experiment in which 3D locations of two moving ground-connected objects were estimated, according to some embodiments of the present invention;

FIGS. 9A-D show results of an experiment in which 3D locations of several moving connected objects based on knowledge of the highest points of each object, were estimated according to some embodiments of the present invention;

FIGS. 10A-B shows an experimental setup used in experiments in which 3D location of a static disconnected object was estimated, according to some embodiments of the present invention; and

FIGS. 11A-F show results of two experiments performed using the setup of FIGS. 10A and 10B.

### DESCRIPTION OF SPECIFIC EMBODIMENTS OF THE INVENTION

The present invention, in some embodiments thereof, relates to image analysis and, more particularly, but not exclusively, to method and system for extracting three-dimensional information by image analysis.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Computer programs implementing the method of this invention can commonly be distributed to users on a distribution medium such as, but not limited to, a floppy disk, a CD-ROM, a flash memory device and a portable hard drive. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method of this invention. All these operations are well-known to those skilled in the art of computer systems.

The method of the present embodiments can be embodied in many forms. For example, it can be embodied in on a tangible medium such as a computer for performing the method steps. It can be embodied on a computer readable medium, comprising computer readable instructions for carrying out the method operations. In can also be embodied in electronic device having digital computer capabilities arranged to run the computer program on the tangible medium or execute the instruction on a computer readable medium.

The image is in the form of imagery data arranged gridwise in a plurality of picture-elements (e.g., pixels, group of pixels, etc.).

The term “pixel” is sometimes abbreviated herein to indicate a picture-element. However, this is not intended to limit the meaning of the term “picture-element” which refers to a unit of the composition of an image.

References to an “image” herein are, inter alia, references to values at picture-elements treated collectively as an array. Thus, the term “image” as used herein also encompasses a mathematical object which does not necessarily correspond to a physical object. The original and processed images certainly do correspond to physical objects which are the scene from which the imaging data are acquired.

In various exemplary embodiments of the invention the method analyzes a stream of imaging data. The stream can be in the form of a series of images or a series of batches of images captured at a rate which is selected so as to provide sufficient information to allow spatial as well as time-dependent analysis. For example, the images can be acquired by a video camera. A single image in a stream of images such as a video stream is referred to as a frame.

The picture-elements of the images are associated with intensity values preferably, but not necessarily, at different colors.

Ideally, the input to the method is the amount of light as a function of the wavelength of the light at each point of a scene. This ideal input is rarely attainable in practical systems. Therefore, the scope of the present embodiments includes the processing of a sampled version of the scene. Specifically, the input to the method of the present embodiments is digital signals resolvable to discrete intensity values at each pixel over the grid. Thus, the grid samples the scene, and the discrete intensity values sample the amount of light. The update rate of the images in the stream provides an additional sampling in the time domain.

Each pixel in the image can be associated with a single intensity value, in which case the image is a grayscale image. Alternatively, each pixel is associated with three or more intensity values sampling the amount of light at three or more different color channels (e.g., red, green and blue) in which case the image is a color image. Also contemplated are images in which each pixel is associated with a mantissa for each color channels and a common exponent (e.g., the so-called RGBE format). Such images are known as “high dynamic range” images.

The present embodiments comprise a method which resolves the three-dimensional location of an object by analyzing occluded regions in a reference image, and optionally and preferably utilizing information pertaining to the parameters of the imaging system.

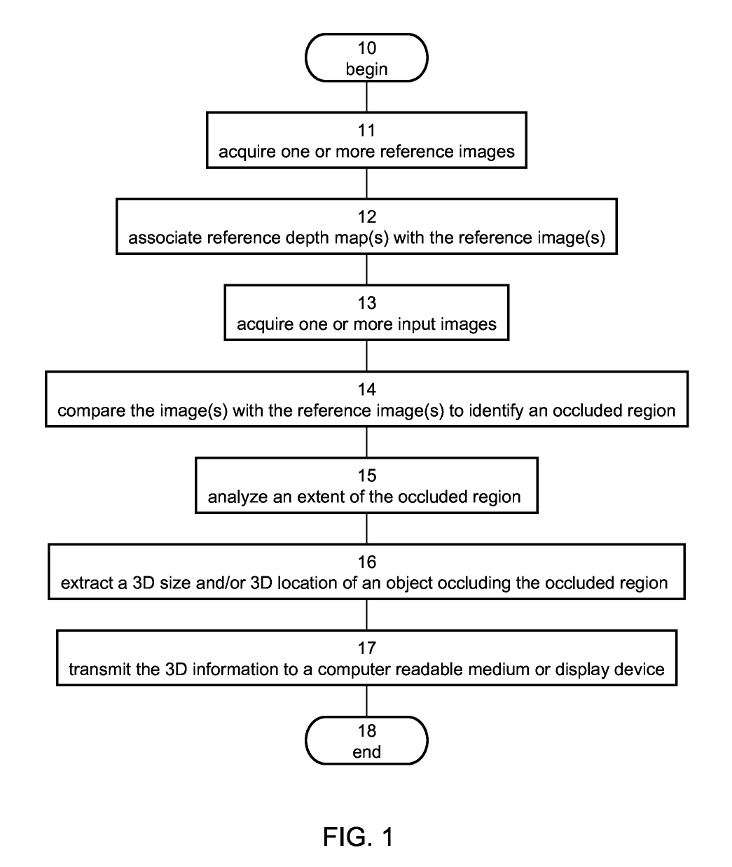

Referring now to the drawings, FIG. 1 is a flowchart diagram of a method suitable for extracting three-dimensional information from an image according to various exemplary embodiments of the present invention. It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

The method begins at 10 and optionally and preferably continues to 11 at which one or more reference images of a scene are acquired. Each reference image is preferably associated with a reference depth map.

A “depth map,” as used herein, is a two-dimensional array of depth values, each being associated with an image location. The depth values in the depth map are distances between the image capturing device and the respective image location.

The size of the reference depth map (namely the number of elements in the array) can vary, depending on the desired resolution. Typically, there is no need for the size of the reference depth map to exceed the number of pixels in the reference image. When the size of the reference depth map equals the number of pixels in the reference image, each element of the depth map has a depth value which is associated with one pixel in the reference image. When the size of the reference depth map is smaller that the number of pixels in the reference image, each element of the depth map has a depth value which is associated with a group of pixels in the reference image. Typical sizes of a depth map suitable for the present embodiments include, without limitation, 176×144, 352×288, 352×240, 640×480, 704×480, 704×576, 1408×1152, 3872×2592, 7648×5408 and 8176×6132 pixels.

When there is more than one reference image, each reference image preferably corresponds to a different viewpoint of the imaging device and is preferably associated with a different depth map.

The depth map can be provided to the method, or the method can acquire depth information, generate the depth map and associates the depth map with the reference image. This embodiment is shown at 12.

Any optical or non-optical depth estimation technique can be employed for constructing the depth map. One technique is range imaging, which is known in the art. In these embodiments, both the reference image and its associated depth map can be acquired simultaneously.

Also contemplated are embodiments in which the angular field-of-view of the recording camera and the altitude and tilt angle of a scanning imaging device are used for constructing a depth map.

Preferred procedures suitable for acquiring a depth map will now be described.

The method receives various parameters, including, without limitation, the field-of-view of the imaging device that acquires the reference image, the position and orientation of the imaging device (e.g., height above the ground level and the tilt angle relative to the vertical direction), the sensor size of the imaging device, the focal length of the imaging device, and the planarity of the ground level. The method can also measure the field-of-view bounding edges distances from the camera and interpolate missing depth information in the areas within the field-of-view. These embodiments are particularly useful when the above mentioned parameters are not known.

For simplicity, the following description is for the case of a planar ground level, but the skilled person, provided with the details described herein, would know how to obtain depth information also for non-planar surfaces of known geometry.

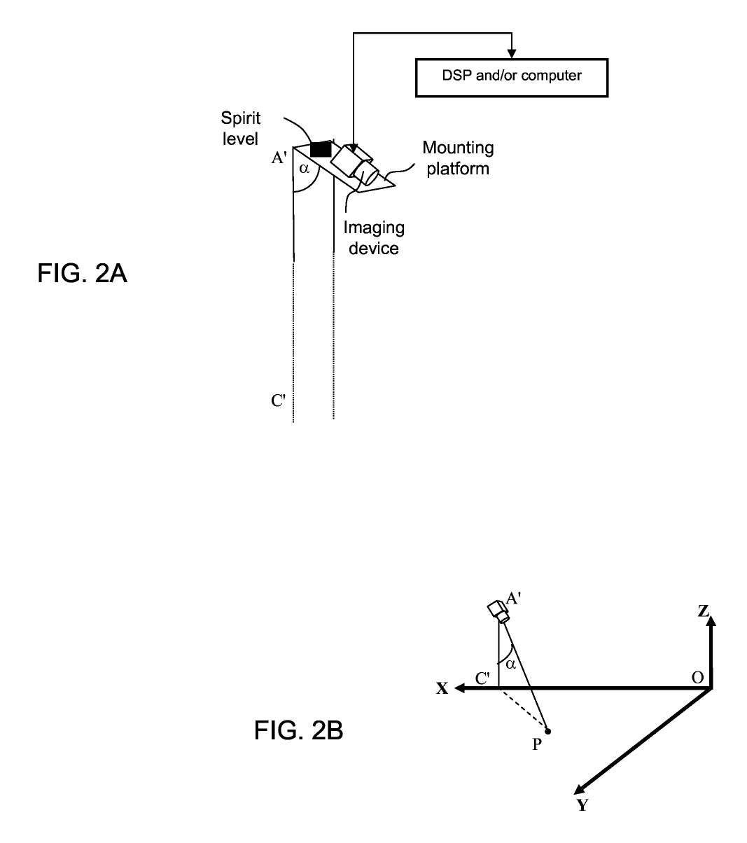

In some embodiments, a platform, such as the platform that is schematically illustrated in FIG. 2A is employed for constructing a 3D coordinate system illustrated in FIG. 2B, wherein the coordinate system includes the depth information. The tile angle α of the platform can be modified and measured or obtained using an angle measuring device such as, but not limited to, a gyroscope, an accelerometer, and the like. The height A′C′ of the imaging device above the ground plane can also be varied. The height A′C′ can be obtained by mechanical measurement or using a vertical laser range finder (not shown).

The angle α, height A′C′, and field-of-view of the imaging device are then used for determining the depth each location in the scene can be obtained using geometrical considerations. For example, referring to point P on the ground plane (FIG. 2B), its distance PC′ from the line A′C′ is given by A′C′ tgα, and its distance A′P from the imaging device is given by A′C′ cos α. The calculations can be performed using any data processing system, such as a digital signal processing (DSP) system or a computer.

Additionally, the method can receives the panning angle of the imaging device, which can remain fixed or can vary to horizontally scan the scene. A device, such as a spirit level, a leveling sensor, a gyroscope or an accelerometer can be mounted to the platform so as to determine the panning angle.

The method of the present embodiments can obtained the depth map of non-planar background surfaces, for example, by means of machine learning algorithms. For example, objects with known height can be tracked across the non-planar surface, wherein at each position of the object, the method extract information regarding the surface properties of the background (e.g., the height of the location relative to a reference plane). Thus, the method gradually learns the properties (e.g., curvature) of the non-planar surface. In various exemplary embodiments of the invention the method acquires, a height map of the surface. Such height map can be a two-dimensional array of height values wherein each height values describes the height of a particular location of the surface above a reference plane, which can conveniently be defined, for example, over a Cartesian coordinate system (e.g., the Z=0 plane).

Also contemplated, are embodiments in which the method receives from an external source the topography of the surface and adjusts this information for the field of view of the imaging device(s).

The method of the present embodiments can obtained the reference image passively, or actively by letting the system learn and differentiate between one object to another, and/or between the objects and the background. In any of the above embodiments, the reference image is optionally a still image or a single frame of a video stream.

The method optionally and preferably continues to 13 at which the image to be analyzed is acquired. The image to be analyzed is referred to herein as the input image. In some embodiments of the invention the method acquires one input image and in some embodiments of the invention the method acquires more than one input image. Also contemplated, are embodiments in which the method receives the input image(s) from an external source (e.g., a remote system), in which case 13 is not executed.

The input image can be a still image or a video stream. When the input image is a video stream, the operations described below are optionally and preferably performed for each of at least a few frames of the video stream, e.g., to each frames of the video stream. In some embodiments of the present invention the input video streams are captured by moving video cameras. In these embodiments, the method preferably receives the motion paths of the video cameras and corrects the input video streams based on the motion paths. The motion paths can be received from an external position tracking system, or, when the motion characteristics are predetermined (e.g., motion along fixed tracks), can be a user input. Alternatively, the method can receives data from motion sensors mounted on the camera and calculate the mention paths based on these sensors.

The method preferably continues to 14 at which the input image is compared with the reference image, so as to identify one or more occluded regions in the scene. This can be done, using any procedure known in the art, including, without limitation, image subtraction, motion segmentation Spatio-Temporal segmentation, and the like. In some embodiments of the present invention the method receives segmentation information from an external source such as a range imaging system (e.g., Time-of-Flight camera).

Optionally and preferably, when subtraction operation is employed, an image segmentation procedure is executed following the subtraction operation. The segmentation operation can segment the input image into a plurality of patches so various objects in the image can be distinguished. Image segmentation, which is generally known per se, is a process that mimics the human visual perception ability to automatically classify similar objects or objects into different types and identify them. For example, image segmentation can feature a smoothing procedure, a thresholding procedure and a post-processing procedure as known in the art.

Segmentation of moving objects in the 3D scene may include segmentations procedures within a single frame and within consecutive frames, e.g., by motion estimation and compensation techniques. Segmentation can include statistical analysis of long observation of the scene, assuming the objects are not static. In some embodiments of the present invention the most frequent grayscale value during long observation of the scene per single picture-element is defined as corresponding to a picture-element that belongs to the background. It should nevertheless be understood that the technique of the present embodiments can be implemented using any other object extraction, identification and segmentation technique.

The method continues to 15 at which the extent of the occluded region is analyzed. This analysis preferably includes determining at least one the boundary, size, shape and orientation of the occluded region. In some embodiments of the present invention the analysis includes estimating a match between the object(s) and its corresponding occluded region so that each occluded area or part thereof, is assigned to a single object. In some embodiments of the present invention the analysis includes selecting or calculating one or more representative points of the occluded region, for example, a center-of-mass point or the like.

The method continues to 16 at which based on said extent, three-dimensional information (e.g., size and/or location) pertaining an object occluding the occluded region are extracted, based on the analysis. When more than one occluded region are identified, the method preferably extract three-dimensional information for each or at least a few of the identified occluded regions.

Following are descriptions of preferred procedures for extracting three-dimensional information.

In some embodiments of the present invention the extraction is based on a single viewpoint of the scene. In these embodiments, there is only one input image, and no additional input images are required, except the reference image to which the input image is compared as further detailed hereinabove.

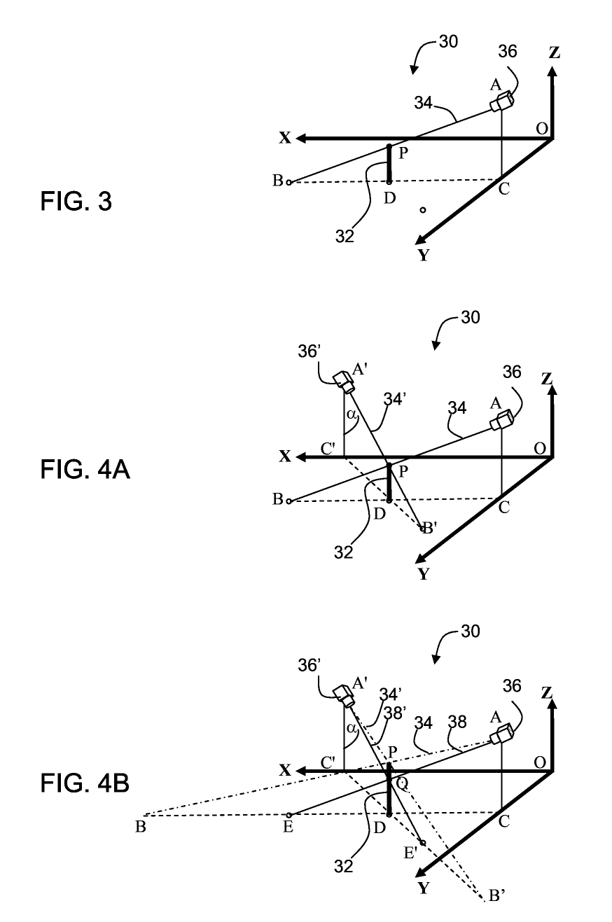

FIG. 3 illustrates a situation in which a scene 30 includes an object 32 which is connected to ground level. For simplicity, object 32 is illustrated as a straight line DP, where D is the point of connection between the object and the ground. The section DB in FIG. 3 represents the occluded region, where B is the boundary of the occluded region. It is appreciated that although the occluded region is shown as having one dimension, the same procedure can be applied for two-dimensional occluded regions.

Thus, the method identifies the region DB, including its boundary B. Using the depth map, the method can determine the location of points D and B, as well as a viewpoint vector 34 describing the optical path between a point of interest on the object and the imaging device 36. The height PD of object 32 and be calculated, for example, based on the geometric relations of the triangle ABC and the triangle PBD. The calculated height is optionally and preferably used as an identification parameter for identifying the object at different times. Thus, the method facilitates three-dimensional object tracking, wherein the location of an identified object is determined as a function of the time.

Although this technique is adequate for determining the location of the object, it may not be sufficiently robust to illumination affects, such as shadows and reflections. For example, when the lower part of object 32 (e.g., the legs of a person or the wheels of a vehicle) is not sufficiently resolvable, e.g., due to shadows and reflections, it is difficult to determine the location of the connection between object 32 and the ground. Another example is when the lower part of object 32 is occluded, either in a crowded or partially crowded environment, or when the object is behind another object (e.g., a person behind a table). The present inventors found that in many situations the higher part of the object is more visible than its lower part, particularly in semi-crowded and crowded environments, and the present embodiments exploit this observation.

The present inventors successfully devised a technique for extracting 3D information even in situations in which the point of connection between the object and the ground is not resolvable. These embodiments are schematically illustrated in FIG. 3. Consider a single object point P(x₁,y₁,z₁) which is disconnected from the ground, and which is the highest point of object 32. The image acquired by an imaging device 36 located at 3D point A(x₂, y₂, z₂) is the projection of the 3D scene with one exception, which is point B(x₃, y₃, z₃) that is occluded by point object P(x₁,y₁,z₁). The point C(x₄,y₄,z₄) is also known since it is the projection of A on the ground. Thus, the method can obtain a line AB. It is recognized that point P(x₁,y₁,z₁) may be located along any point along the optical line AB. In various exemplary embodiments of the invention the method uses the height of the point P(x₁,y₁,z₁) to calculate the distance of object 32 from the recording camera.

The height of point P can be received by the method, for example, as a user input. The method can also receive the height of point P from an external source, such as, but not limited to, a range imaging device.

In some embodiments of the present invention the height of object 32 is estimated instead of being a user input. For example, when the object is a person, an estimation of its height can be based on the average height of the population or by measuring the length of the human hands. Alternatively, an additional device e.g., a range imaging device, can be used for determining the height of the object.

In some embodiments of the present invention the height of object 32 is calculated in one of the previous frames (e.g., based on knowledge of the location of object 32 relative to the imaging device, based on the camera height and based on the occluded point at the background depth map).

The method of the present embodiments can be used also while the imaging device is moving (translation and/or rotation), as well as when the imaging device performs a zooming operation (zooming-in and/or zooming-out). In these embodiments, the method preferably calculates or receives the field-of-view of the imaging device and uses the calculated or received field-of-view for segmenting out the object and determining its location based on the reference depth map. For example, the method can receives the motion path and/or zooming rate of the imaging device and calculate the field-of-view based on the received path or zooming rate.

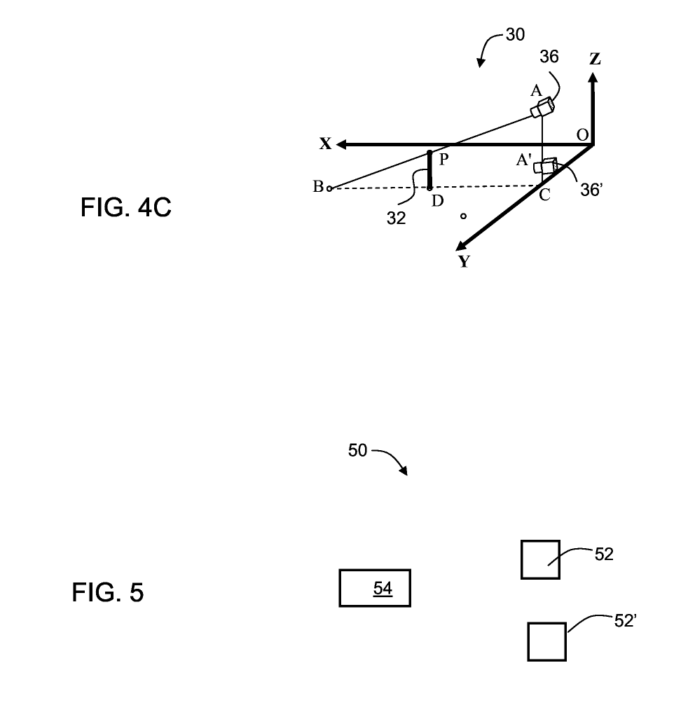

In some embodiments of the present invention the extraction is based on two or more viewpoints of the scene. These embodiments are schematically illustrated in FIG. 4A.

Consider a single disconnected ground plane point object P(x₁,y₁,z₁). The image acquired by an imaging device 36 located at 3D point A(x₂,y₂,z₂) is the projection of the 3D scene with one exception, which is point B(x₃,y₃,z₃) that is occluded by point object P(x₁,y₁,z₁). The point C(x₄,y₄,z₄) is also known since it is the projection of A on the ground. Thus, the method obtains a line BC which is the projection of a viewpoint vector 34 (line AB) on the ground plane XOY. The method repeats the same principle with a second imaging device 36′ located at point A′(x₅,y₅,z₅), to obtain line C′B′, which is the projection of a second viewpoint vector 34′ on the ground plane. The method then calculates the intersection point of lines CB and C′B′ to provide point D(x₁,y₁,z₆), which to is the point of contact between object 32 and the ground. The point P(x₁,y₁,z₁) can then be estimated using the geometrical relations between triangles ABC and PBD:

P_{ABC}(x,y,z)=P(x₁,y₁,z₁)=AC·BD/BC (EQ. 1)

or between triangles A′B′C′ and PB′D:

P_{A′B′C′}(x,y,z)=P(x₁,y₁,z₁)=A′C′·B′D′/B′C′ (EQ. 2)

Knowing the 3D location of points objects P(x₁,y₁,z₁) and D(x₁,y₁,z₆) allows determining the location and height of line DP.

Alternatively, the line DP can be determined is to estimate the intersection line of the planes ACB and A′C′B′ at the 3D space.

When the scene includes more than one object, particularly when the scene includes several moving objects, the method optionally and preferably employs a weighting procedure for selecting the appropriate location of the object. Thus, in some embodiments of the present invention the size of a particular object, as extracted based on one viewpoint vector, can be compared with the size of this particular object, as extracted based on another viewpoint vector. This comparison is optionally and preferably used for defining a weight which can be applied for the purpose of determining the location of the object.

For example, referring to the non-limiting illustration of FIG. 4A, the method preferably calculates DP using EQ. 1 to provide a first height h, and then re-calculates it using EQ. 2, to provide a second height h′. Since scene 30, as stated, may include several object, it may happen that h and h′ correspond to different objects in the scene, since, for example, two or more ground plane lines originating from C may intersect with one or more ground plane lines originating from C′. The method thus repeats the two calculations for each such point of intersection, so that a pair of heights is obtained for each point of intersection. The method can then define a weight Λ as a function of h and h′, e.g., as a function of the difference h−h′, and select, for each object, a pair triangles that optimize Λ. The method can estimate the height of the object as the average of h and h′. Representative examples for Λ(h,h′) include, without limitation, Λ(h,h′)=|h−h′| and Λ(h,h′)=(h−h′)². In these examples, the method preferably select the pair of triangles that minimize Λ. Alternative examples for Λ(h,h′) include, without limitation, Λ(h,h′)=1/|h−h′| and Λ(h,h′)=1/(h−h′)². In these examples, the method preferably selects the pair of triangles that maximize Λ. Other expressions for the weight function Λ are not excluded from the scope of the present invention.

In simpler situations, such as the situation illustrated in FIG. 4A, wherein the intersection point D is known, the height of P above the ground level can be estimated according to any of EQs. 1 and 2.

While the above embodiments were described with a particular emphasis to an elevated point P which is the highest point of object 32, it is to be understood that more detailed reference to the highest point of object 32 is not to be interpreted as limiting the scope of the invention in any way. Since the depth map of scene 30 is known, similar operations can be executed for locating any other point on object 32. A representative and non-limiting example is illustrated in FIG. 4B, wherein the method estimate the location on object 32 of a point Q between P and D. Any of the above procedures can be employed, except that the analysis of the occluded regions CB and C′B′ includes determination of internal points E and E′, respectively. These internal points respectively correspond to viewpoint vectors 38 and 38′, which are used by the method to determine the location of Q substantially in the same manner as described above with respect to viewpoint vectors 34 and 34′.

In the embodiments illustrated in FIGS. 4A and 4B the two viewpoints are at different sides of object 32. However, this need not necessarily be the case, since, for some applications, it may not be necessary for the viewpoints to be at different sides of object 32. A representative example of an embodiment in which the employed viewpoints are at the same side of object 32 is illustrated in FIG. 4C. Shown in FIG. 4C is a construction in which first 36 and second 36′ imaging devices are positioned one above the other, such the point C is the projection of both points A and A′. These embodiments are particularly useful when the height of object 32 is known (calculated, measured, estimated or received), wherein the imagery data from second imaging device 36′ can be used for vertically slicing the object. Once the height of each slice of object 32 is known, its 3D location with respect to the main part of the object can also be estimated using the above techniques, hence sections 3D shape of the observed objects may be obtained as well.

It is appreciated that determination of the location of several points on object 32 can be used to estimate the shape of the object, hence also to shape-wise distinguish between objects and/or determine a posture of the object. Useful applications for these embodiments are described hereinunder.

The characteristic depth resolution of the method according to some embodiments of the present invention is given by the following expressions:

Δz=max{Δzᵢₙₚᵤₜ,Δx};Δx=max{λ/NA,δ/M} (3)

where Δzᵢₙₚᵤₜ is the depth resolution of the a priori depth map, Δx is the minimal transversal resolvable detail of the imaging system, NA and M are the numerical aperture and the magnification of the imaging system, respectively, δ is the pixel size of the recording camera, and λ is the average wavelength used.

In various exemplary embodiments of the invention the method continues to 17 at which the method transmits the extracted 3D information to a computer readable medium or a display device.

The method ends at 18.

Reference is now made to FIG. 5 which is a schematic illustration of a system 50 for extracting three-dimensional information, according to some embodiments of the present invention. System 50 comprises at least one image capturing system generally shown at 52 and 52′, and a data processor 54 which preferably configured for performing one or more of the operations described above.

Before providing a further detailed description of the inventive technique, attention will now be given to the advantages and potential applications offered by some embodiments of the present invention.

The technique of the present embodiments can be employed in 3D surveillance system for both sparse and crowded environments of connected and disconnected flat ground objects. For example, a high altitude camera, such as, but not limited to, a spaceborne camera, an airborne camera, or a camera which is mounted within a high altitude infrastructure above ground such as a road lamp, a high altitude building, a traffic light, mounted on high location on the wall or ceiling of an indoor environment etc., can be used as an imaging device for acquiring the input and/or reference images and/or depth map.

The technique of the present embodiments can be used in a traffic control system, for controlling traffic on roads, railway tracks, seas, channels and canals. The depth map employed by the traffic control imaging system can be updated continuously either by an internal computer within the vehicle, or by an outside main computer which transmits to the driver the relevant and updated 3D information of the vehicle motion path and its surroundings and may signal alarms in risk scenarios.

Also contemplated are embodiments in which the inventive technique is incorporated in indoor traffic control systems, e.g., for controlling motion of a crowd within an indoor facility. In various exemplary embodiments of the invention the traffic control system is placed in high risk areas, such as schools, kindergartens, and railway crossings.

Such traffic control systems can improve safety and enforcement capabilities. For example, improved enforcement can be achieved on roads by automatic detection of high risk behaviors of different vehicles, such as speeding, dangerous passing, etc. Safety may be achieved by assigning to a vehicle a real time visual image, 3D information, and automatic alerts in case there is a risk (e.g., high likelihood of an accident). For example, a traffic control system can provide to a particular vehicle indication regarding nearby vehicles having motion characteristics that may lead to a crash, or information regarding objects on roads. A visual image can be transmitted to a decoder placed in the interior of the vehicle for presenting the information to the driver or passenger.

The traffic control system of the present embodiments is optionally and preferably configured to react to identified situations (e.g., high risk scenarios) substantially in real time (e.g., within 1 sec, more preferably within 100 ms, more preferably within 40 ms or 33 ms, or more preferably within 10 ms, or more preferably within 1 ms). For example the traffic light system of the present embodiments can detect a vehicle that is about to pass a red light signal and generate an alert or stop the entire traffic at an intersection by setting a red light signals in all directions at the intersection for both vehicles and pedestrians.

In various exemplary embodiments of the invention the traffic control system is configured to estimate the number of vehicles at the intersection. Based on this estimate, the traffic control system can signal a network of traffic lights so as to improve the traffic flow, or to open a fast route for emergency vehicles. One or more traffic flow scenario can be implemented so that the final decision regarding the timing of each traffic light in the network is weighed according to this scenario. A weight function can be calculated based on various parameters, such as, but not limited to, the number of vehicles in each direction, the type of vehicles (for example, an emergency vehicle or vehicles that belong to a group of users, e.g., citizens of the city with prioritized privileges).

The traffic control system can also be configured to provide a payment based prioritized privileges. In these embodiments, the traffic control system preferably receives payment and identification data from a payment control system. In some embodiments of the present invention the traffic control system controls the traffic lights locally based on immediate payments. For example, a particular vehicle waiting in a red light at a particular junction may transmit a payment signal while waiting so as to shorten the waiting time at that particular junction. The traffic control system can receive payment indication and vary the timings accordingly.

The technique of the present embodiments can be incorporated in a vehicle imaging system, wherein one or more imaging devices having a field of view of the exterior of the vehicle are mounted on the vehicle. A data processor which is associated with the imaging devices executes the method as described above and provides the extracted 3D information to the interior of the vehicle, e.g., by displaying the information on a display device or generating an alert signal. In various exemplary embodiments of the invention the data processor is placed in the vehicle and performs the analysis in an autonomic manner.

The depth map employed by the vehicle imaging system for can be updated continuously either by an internal computer within the vehicle, or by an outside main computer which transmits to the driver the relevant and most updated 3D information of the vehicle motion path and its surroundings.

In any of the embodiments of the present invention the information (input image, reference image and depth map) can be acquired during high imaging conditions (e.g., during daytime), or, using an appropriate imaging device, also in less than optimal imaging conditions, such as during nighttime rain and/or fog. For the latter embodiment, the imaging device is preferably selected to be sensitive, at least in part, to non-visible light (at different bands of the entire electromagnetic spectrum) which allows imaging at the respective conditions.

The technique of the present embodiments can also be utilized in an automatic cars infrastructure, or in a controlled infrastructure within the railway transportation systems to ensure safer train traffic along railway tracks.

The technique of the present embodiments can also be used for tracking individuals, particularly with individuals impaired motion capabilities, e.g., blind individuals, partially sighted individuals, infants, elderly individuals, individuals with epilepsy, individuals with heart problems, so as to aid those individuals in orientation or reduce risk of stumbling and falling. This can be done at home or at any other indoor or outdoor facility, including, without limitation, public transportation, buildings, sidewalks, shopping centers and hospitals.

The technique of the present embodiments can estimate the risk of the respective individual at any given point of time at which the analysis is performed. For example the technique of the present embodiments can used the extracted three-dimensional information for estimating the risk of falling from a bed or from a wheel chair, falling while walking, approaching high risk areas, leaving a predetermined area and the like. This can be done by analyzing the posture and motion characteristics (speed, direction) of the individual and estimating the likelihood of a high risk event to occur. An alert signal can be generated and transmitted either to the respective individual or a different individual who can assist in resolving the situation. An alert signal can also be transmitted to a central control unit.

The technique of the present embodiments can collect history data regarding posture and motion characteristics and use the history data for determining the likelihood that the monitored individual is about to fall or the likelihood for changing posture that might lead to a fall. For example, the method can detect hands reaching for support and use such detection to predicted falling. The technique of the present embodiments can also detect obstacles that may cause a fall. The technique of the present embodiments can perceive the location of the obstacle, track the motion of the individual, and generates a warning signal once the individual is about to collide with the obstacle.

The technique of the present embodiments can detect a fall once an abrupt change of height of the monitored individual (e.g., below the standard height of the individual, or below a certain height for a certain period of time) is identified. The technique of the present embodiments can also track velocities changes of human movements. For example, if the height of the monitored individual is estimated below a specific threshold of the typical height of that individual for a predefined time, the method can determine that the individual has fallen, and generate an alert signal.

Fall prevention may be implemented as soon as the system senses a risky situation for the monitored individual and generates a warning signal (such as a voice signal, SMS, flashing lamp, etc.) so that nearby personal assistance is provided. Examples of risky situations, include, without limitation, pose transition from lying down to sitting on a bed, observation of certain types of movement together with height changes while sitting on a chair or a wheelchair, etc.

Several technologies are known for prevention and detection of falls Bourke et al., Proceedings of the 24th IASTED international Conference on Biomedical Engineering, pp. 156-160, 2006; Doughty et al., Journal of Telemedicine and Telecare, vol. 6, pp. 150-154, 2000; Kangas et al., Gait & Posture, vol. 28, issue 2, pp. 285-291, 2008; Kangas et al., Proceedings of the 29th Annual International Conference of the IEEE, Engineering in Medicine and Biology Society, pp. 1367-1370, 2007; Noury et al., Proceedings of the 25th Annual International Conference of the IEEE, Engineering in Medicine and Biology Society, vol. 4, pp. 3286-3289; Fredriksson et al., U.S. Pat. No. 7,541,934; Fu et al., Proceedengs of the IEEE International Symposium on Circuits and Systems—ISCAS 2008, pp. 424-127, 2008; Caroline et al.)].

However, many of these technology are costly, technologically difficult to employ, or otherwise not practical. Wearable intelligent solutions, such as accelerometers and gyroscopes are found to be reliable, but tend to have high false alarm rate, and many of the elderly do not wear them all the time. Additionally, some individual tend to forget wearing the device, or report that it reduces comfort.

Some known non-wearable fall detection solutions do not include posture reconstruction. However, the present inventors found that those solutions are inadequate, in particular in identifying different types of falls. Simple sensors, such as passive infrared sensor, provide too rough data that is difficult to process and analyze.

Unlike the above techniques, the method of the present embodiments is based on 3D tracking which is capable of estimating the location and posture of the monitored individual. Thus, the present embodiments provide improved capabilities for detecting height changes and falls.

Also contemplated are embodiments in which the extracted 3D information is combined with a wearable sensor for falls detection, such as a gyroscope, an accelerometer, an alert bracelets, a panic button, or any other wearable emergency medical alert instrument which is equipped with a movement sensor and transmitter. Such combination has several operational functions which reduces false alarms, falls misses, and time duration until assistant is provided.

A fall detection system according to some embodiments of the present invention is preferably combined with different types of wearable sensors in order to create different types of movements “signatures” and characterization of an individual. The system can record certain types and amount of movements, and different types of changing positions can be recognized from the extracted 3D information. The history of the movements as recorded by the sensor can be analyzed and related to the extracted 3D information. The relation between sensor readings and 3D information is optionally and preferably performed by machine learning techniques. These relations can be used to construct a subject-specific database which associates sensor readings with 3D information, or more preferably, with falling likelihoods. Once the subject-specific database is constructed it can be used for detecting and optionally predicting falls. Specifically, once a sensor receives part of a known signature of a certain movement that might put the individual at risk, the system can send an alert to the supervisor station and/or remind the individual to avoid the specific risky action he is about to do thereby increasing the reaction time.

In various exemplary embodiments of the invention a fall is detected only when both the wearable device and the extracted 3D information identify a fall. These embodiments are advantageous since they reduce false alarms.

The extracted 3D information can be used for determining whether an individual at risk does not wear the wearable devise (for example, once the extracted 3D information indicates motion, while the wearable devise does not indicate movement). In these embodiments, the system optionally and preferably alerts the individual to wear of activate the device.

In order to maintain privacy and bring the intrusion to a minimum, the 3D tracking system can be configured to become operative only when the wearable device is inactive or not worn for a certain period of time.

When placing the imaging device is placed, for example, above the bed of the individual, the system can detect the location at which the individual is lying or sitting. If the location becomes risky, the system can generate an alert, to a control station or an assisting individual, or the individual at risk.

The technique of the present embodiments can also be utilized for controlling artificial environmental conditions. For example, the inventive technique can track motion and position of individuals in a large indoor facility, and instructs an artificial environment control system (e.g., a lighting control system, an air-condition control system, a heating system, an audio control system) to vary the environmental conditions (light, temperature, sound level) based on the extracted information.

For example, a camera can be mounted on an air-conditioning system. Unlike existing solutions of smart air-conditioning systems, the technique of the present embodiments can automatically detect the 3D location of the moving objects, and according to the location of the tracked objects, the air-conditioning system adjusts and/or divide, if necessary, the air-conditioning power. Optionally and preferably the technique of the present embodiments detects the height of the individuals near the air-conditioning system so as to distinguish, for example, between human and non-human moving objects (e.g., between humans and small animals), wherein the air-conditioning system can be configured not to consider non-human objects in the decisions regarding distribution of air-conditioning power. The air-conditioning system of the present embodiments can also be configured to detect crowded areas in the indoor facility, and to estimate to the number of moving objects in these areas. The system of the present embodiments can then adjust the power concentration, based on such estimates.

The technique of the present embodiments can also be utilized in a position tracking system, particularly, but not exclusively, in indoor environments, such as, but not limited to, airport terminals, railway stations, shopping centers, museums and the like. Such system can be useful, for example, in business intelligence and personalized marketing field. This system can estimate, generally in real-time (e.g., within 1 sec, more preferably within 100 ms, more preferably within 40 ms or 33 ms, more preferably within 10 ms, more preferably within 1 ms), the location of customers in the indoor facility. The position tracking system can, in some embodiments of the present invention, include or be operatively associated with an access-point (AP) or several access-points (APs), in which case the system optionally and preferably gather visual information and relate it, automatically, to individuals. AP, in this context, means a station, or a network of stations, in wireless infrastructure technology that can calculate the position of a mobile user in the network.

The technique of the present embodiments can be used as a supplementary technique for one or more additional positioning techniques, including, without limitation, a positioning technique based on at least one of: range imaging, e.g., Time-of-Light imaging devices, and a positioning technique based on wireless technology, such as, GPS, Wi-Fi, Bluetooth, location sensors. Such techniques are known to possess a level of uncertainty since they obtain more than one candidate solution for the location of objects. The present embodiments can therefore be used for improving the accuracy of these techniques.

Positioning of pedestrians is useful in various fields and applications such as, security, navigation, business intelligences, social networks, location base services (LBS), etc. Known outdoor positioning techniques include satellite-based techniques, e.g., global positioning system (GPS), and cellular network based techniques employing cellular identification codes in combination with various types of algorithms, such as Time-Of-Arrival (TOA), Time Difference-Of-Arrival (TDOA), and Angle-Of-Arrival (AOA). For indoor positioning, however, these techniques are far from being optimal.

Also known are alternative or complimentary positioning technologies to GPS, such as WiFi, RF, IR, Bluetooth, RFID, UWB, Sensor Networks and MEMS (accelerometers and gyroscopes) [Liu, H., H. Darabi, P. Banerjee, and J. Liu, “Survey of wireless indoor positioning techniques and systems,” IEEE Transactions on Systems, Man, and Cybernetics, Part C: Applications and Reviews, Vol. 37, No. 6, 1067-1080, 2007]. WiFi location technology can be used to derive fine resolution location but relies on proximity to WiFi equipped structures and lacks the ability to provide elevation information and can not provide which floor the person is or where exactly the person within the building; nor will it be viable in remote locations where access points are not available.

WiFi can operate according to triangulation principle, and according to scene analysis principles. The present inventors found that in indoor environments, the resolution performances are correlated with the number of hotspots or APs employed in the scene, and that in many cases it is complicated and expensive setup to deploy large number of hotspots or APs.

Ultra wideband and RF tagging technologies are able to provide precision location information but require substantial pre-configuration of spaces and materials and are not suitable to applications that require timely, generic, adaptable, and ad-hoc tracking solutions. Sensors, for indoor navigation, are only part of the solution and they will be combined with other technologies such as WiFi and cell tower triangulation, Bluetooth and cameras.

The position tracking system of the present embodiments can provide three-dimensional tracking also in indoor environments and can, in some embodiments, do it passively, namely without transmitting radiation. Additionally, the present embodiments do not require the tracked object to transmits any type of energy, expect reflecting radiation already existing in the environment (e.g., light) and/or generating infrared radiation as a result of the natural temperature of the tracked object. The system of the present embodiments preferably tracks pedestrians using standard cameras equipped with standard lens and/or Fisheye lens. In some embodiments of the present invention this application a camera with a Fisheye lens (or several cameras with standard lenses) is added to an AP or a beacon, or to a network of APs. It is to be understood that the AP or beacon and the additional camera do not necessarily share the same physical location. In some embodiments of the present invention the AP or beacon and the additional camera communicate with each other from different locations.

The synchronization between the positioning information obtained with the wireless positioning technologies and the depth map obtained with the standard camera according to some embodiments of the present invention, is advantageous from the following reasons.

Accuracy and reliability of the positioning information is improved once two technologies are combined [T. Miyaki, T. Yamasaki, K. Aizawa, “Multi-Sensor Fusion Tracking Using Visual Information and WiFi Location Estimation,” Fifth ACM/IEEE International Conference on Distributed Smart Cameras (ICDSC), Vienna, Austria, 2007; C. ‘O'Conaire, K. Fogarty, C. Brennan, N O'Connor, “User Localization using Visual Sensing and RF signal strength,” Sixth ACM Conference on Embedded Networked Sensor Systems (SenSys), Raleigh, N.C., USA, 2008]. For example, the combination of three-dimensional tracking technique of the present embodiments with an AP or beacon, allows deterring the location and optionally also altitude of the respective individual.

Another advantage is that the combination increases the coverage area, hence allows reducing the amount of APs and beacons in the indoor facility. In conventional techniques, accuracy can only be increased using many APs. The presence embodiments allow the use of imaging devices that are already installed in the environment, thereby providing high positioning accuracy with fewer infrastructures. Alternatively or additionally, the number of imaging devices that are deployed can be increased using imaging devices with wide field of view coverage and/or high resolvable resolution. While these embodiments do require increasing the infrastructure, it is recognized that it is simpler and less expensive to deploy imaging devices than to deploy APs and beacons.

Another advantage is that unlike conventional technologies, the position tracking system of the present embodiments, as stated, can provide three-dimensional positioning passively and without depending on transmissions of any type of energy (expect reflection already existing radiation and/or generating infrared radiation as a result of the natural temperature of the tracked object). This means that once the two technologies are combined and synchronized in accordance with some embodiments of the present invention, the energy consumption at the mobile user side can be reduced, since once the tracking is handled successfully by the imaging devices, the tracked object can switch off its active signaling mechanism. This also reduces the computational load.

An additional advantage relates to the identification of an individual. Wireless positioning technologies allow assigning an estimated location to a specific mobile device (such as mobile phone and/or portable device and a like). Each mobile device obtains a unique identification code, such as Physical address and/or MAC address and/or an IP address and/or a phone number. The position tracking system of the present embodiments, on the other hand, allows assigning the location to a specific individual. Thus, in some embodiments of the present invention, once the position of a mobile device is sufficiently close to the location of the respective individual and/or once a correlation exists between the movement directions and/or velocity of an individual based on the two positioning technologies, the respective identification code is assigned, for example, at a central location, to an image of the respective individual. Thus, the present embodiments allow constructing a data base that relates a specific identification code to a specific visual description of the individual. In some embodiments of the present invention the present embodiments associate a specific identification code to a specific visual face description. This database can optionally and preferably associate to a specific visual and an identification code also the location and time of a specific event.

Generally, the database according to some embodiments of the present invention associate a specific visual of a person (e.g., facial visualization) to any identification code, including, without limitation, a vehicle, a license plate, a mobile phone number, and the like. Such information, which can be obtained both indoor and outdoor, can enhance security capabilities as well as business intelligence decisions.

The technique of the present embodiments can estimate and grade the quality of the visualization of an object. This is typically done by determining the relative location between the imaging device and the object of interest, and whether or not the object is occluded by another object, and using these determinations for assigning a visualization score to the object in the respective image or frame. Optionally and preferably the technique of the present embodiments automatically decides, based on the assigned score, whether or not to store in records the visualization of the object in the image or frame.

The present embodiments successfully provide a visual communication system utilizing the inventive technique. Such a visual communication system can be deployed in any communication region, for example, in various types of event venues, including, without limitation, conventions, conferences, businesses meetings, trade shows, museums and the like. The system comprises a one or more APs or beacons, an arrangement of imaging devices and a data processor. The data processor receives images from the imaging devices and determine three-dimensional locations of individuals in the images.

The imaging devices can be of any type. For example, when the imaging devices are passive, the data processor can extract three-dimensional information as further detailed hereinabove. When the imaging devices include one or more range imaging devices, the data processor can extract three-dimensional information using range data provided by the range imaging devices. The three-dimensional information is transmitted using the AP or beacon over the communication region so that at least one individual over the region receives the location and visualization of at least one tracked individual over the region. Optionally and preferably the receiving individual is also provided with an identification of the tracked individual.

In some embodiments of the present invention the receiving individual transmits, via the AP or beacon, a request for locating the tracked individual by providing an identification code of the tracked individual. The data processor then receives the requests, identifies the tracked individual as further detailed hereinabove, and to the receiving individual transmits the location and current visualization of the tracked to the individual, responsively to the request. Thus, not only that a single individual is able to know the location of another individual in an event, he or she can also know the most updated visual of the person he is interested to meet, information that is valuable especially in crowded areas or in case those people do not know each other.

The technique of the present embodiments can also be used for bridging between different positioning wireless systems, by communicating with each of the systems. Specifically, the technique of the present embodiments can be used for bridging between positioning system X and positioning system Y, wherein each of X and Y is selected from the group consisting of at least GPS, WiFi, Cell-ID, RFID and Bluetooth. These embodiments are particularly useful when a user moves from one environment to another. For example, when a user moves from an indoor environment to an outdoor environment, the inventive method and system can be used for bridging an indoor positioning system to an outdoor positioning system.

Thus, a bridging system for bridging a first positioning system to a second positioning system, according to some embodiments of the present invention, comprises a first arrangement of imaging devices deployed in environment sensed by the first positioning system, a second arrangement of imaging devices deployed in environment sensed by the second positioning system, and a data processor. The data processor includes are is associated with a communication module which allows the data processor to communicate with both arrangement of imaging devices and both the first and second positioning systems.

In use, the data processor receives location data from the first and second positioning system, and images from the first arrangement of imaging devices. The data processor then analyzes the images as further detailed hereinabove for tracking one or more individuals at or near the location defined by the received location data. The data processor continues the tracking, at least until the individual(s) moves from the first environment to the second environment. When the tracked individual(s) is in the second environment, the data processor transmits to the second positioning system location data pertaining to the location of the tracked individual(s) within the second environment, thereby allowing a substantially continuous tracking (e.g., at intervals of less then 10 seconds or less than 1 second) of the individual(s) while moving from the first environment into the second environment.

Also contemplated are embodiments in which an active range imaging system (e.g., time-of-flight camera) equipped with standard lens and/or Fisheye lens, is combined with AP or a beacon, as further detailed hereinabove.

The technique of the present embodiments can also be used in combination with active range imaging systems, including, without limitation, time-of-flight systems and the like.

Commercially available time-of-flight cameras, such as PrimeSense/Kinect™, D-imager™, PMDTec™, Optrima/Softkinetic™ and Mesa Swissranger™, measure the time of flight of near-infrared (NIR) light emitted by the camera's active illumination and reflected back from the scene. The illumination is modulated either by a sinusoidal or pseudonoise signal. The phase shift of the received demodulated signals conveys the time interval between the emission and detection, indicating how far the light has traveled and thus indirectly measuring the depth of the scene, and due to the periodicity in the modulation signal, these devices have a limited working range, usually only up to several meters. Distances beyond this point are recorded modulo of the maximum depth, known as wraparound error.

The present inventors contemplate using the 3D information as extracted from analysis of occluded regions for the purpose of extending the maximal range imaging distance of an active range imaging system. This can be done, for example, by synchronizing the depth map obtained with the time-of-flight cameras and the depth map obtained from passive imaging using geometrical considerations as further detailed hereinabove. Such synchronization can be used for correcting wraparound errors introduced by the time-of-flight system. Specifically, passively obtained 3D information, particularly information pertaining to regions which are beyond the maximal attainable distance of the range imaging system, can be transmitted to the range imaging system, thereby increasing the attainable range without modification of the frequency modulation and/or without contributing to the wraparound errors. Such combination can facilitate use of higher frequency modulations for active range imaging, thereby also improving the resolution and signal strength, and without affecting the attainable range.

In some embodiments of the present invention the technique is employed in an interactive computer game system. The advantage of the present embodiments over existing technologies, such as Wii™ and KINEKT™, since the present embodiments do not require active illumination, complicated setup, or specially designed equipment. Once the highest point of each player on the scene is estimated, the present embodiments estimate the height or the vertical coordinate of additional points on the body of the player. Then, a segmentation procedure or temporal search of specific parts of the player's body (e.g., hands, legs, elbows, knees, etc.) is employed to estimate the location of different 3D locations of different body parts, based on the estimated height and the inventive occlusion analysis technique.

Alternatively, the computer game system of the present embodiments can be combined with an active game system, such as, but not limited to, KINEKT™ and Wii™. Such combination can speed-up the response time of the active game system and improve the gaming experience.

Additional applications contemplated by the some embodiments of the present invention include, without limitation, a 3D assistant system for autonomous vehicles; and a system for tracking and recording 3D positions of objects for entertainment and movie industries.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

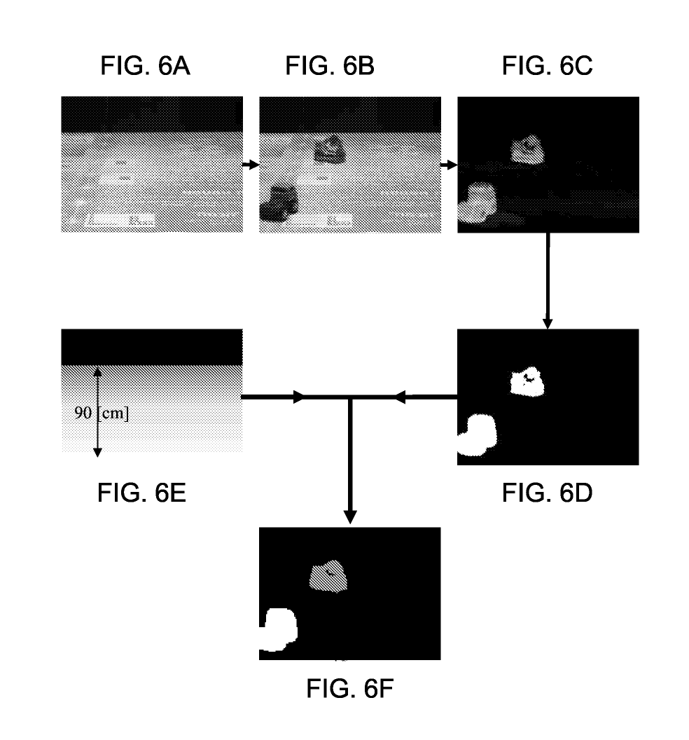

A prototype system has been constructed and tested in accordance with some embodiments of the present invention. The procedures used for extracting 3D information based of a single view camera are presented in FIGS. 6A-F and 7A-D.

FIGS. 6A-F show a procedure for extracting 3D information when the point of contact between the objects and the ground are resolvable. FIG. 6A shows a background intensity reference, FIG. 6B shows moving objects in the scene, FIG. 6C shows and inter-frame subtraction result, FIG. 6D shows the result of the segmentation procedure, FIG. 6E shows a depth map which was realized as a coordinate reference map, and FIG. 6F shows an estimation of the 3D location of the object.

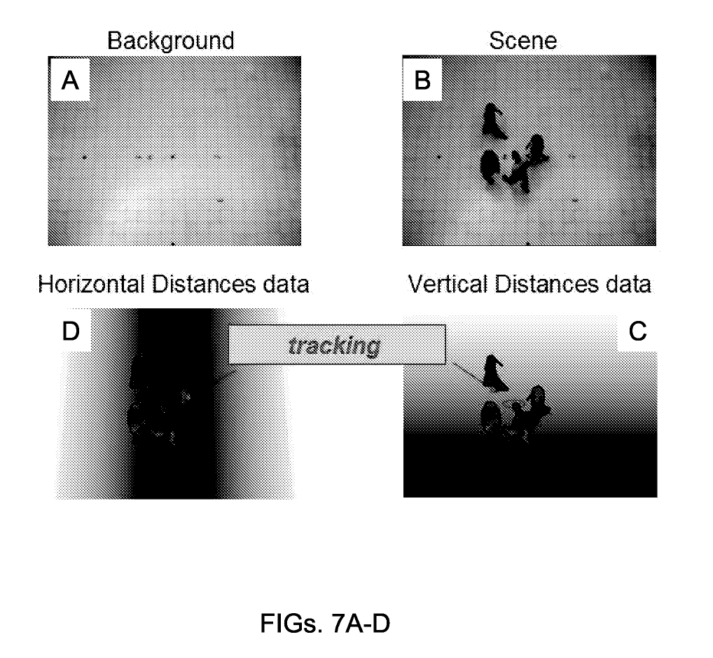

FIGS. 7A-D show a procedure for extracting 3D information when an elevated point is employed for the analysis. This procedure is useful when it is difficult to identify the point of contact between the object and the ground. The images in FIGS. 7A-D were taken by a single camera, positioned 12 m above ground level.

FIG. 7A shows the reference image, FIG. 7B shows the input image, FIG. 7C shows segmented objects on top of vertical distances (depth) data, and FIG. 7D shows segmented objects on top of horizontal distances (distances from the center of optical axis) data. The shadowing affects and occlusions are noticeable in FIGS. 7A-D, even for high altitude camera mounted at 12 m above ground.

Following is a description of three experiments conducted to demonstrate the ability of the inventive method to extract 3D information based on occluded region analyses.

A first experiment was directed to the estimation of 3D locations of two moving connected objects, a second experiment was directed to the estimation of 3D locations of several moving connected objects based on statistical knowledge of the highest points of each object, and a third experiments was directed to the estimation of 3D location of a static disconnected object.

In the first experiment a sequence of 160 frames, at the rate of 25 frames per second, has been recorded by a digital camera (uEye, Gigabit Ethernet UI-5480-M). The 3D scene in this experiment has contained a background and two moving foreground objects, each 75 mm×75 mm×75 mm in size. Fast estimation of the locations of the lowest part of each object was carried out as further detailed hereinabove.

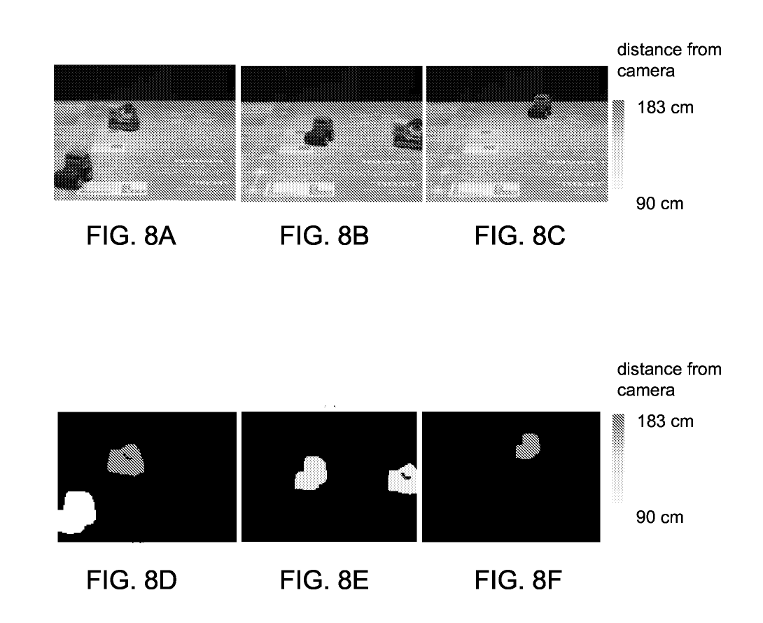

Frames numbers 55, 75 and 140 and their corresponding 3D locations, as have been estimated according to some embodiments of the present invention, are presented in FIGS. 8A-C and 8D-F, respectively.

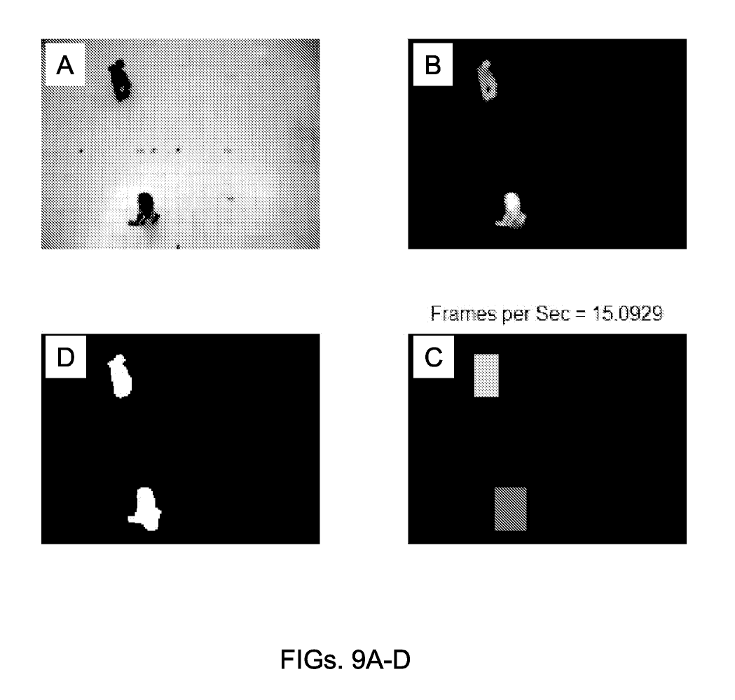

In the second experiment, a sequence of 540 frames, at the rate of 15 frames per second, has been recorded by a digital camera (uEye, Gigabit Ethernet UI-5480-M). The 3D scene in this experiment contained several moving foreground people. The camera has been located 12 m above a plane floor. Fast estimation of the locations of the highest part of each object was carried out as further detailed hereinabove for disconnected objects. Frame number 232 and its corresponding segmented and estimated depth, as have been estimated by the proposed method, are presented in FIGS. 9A-D.

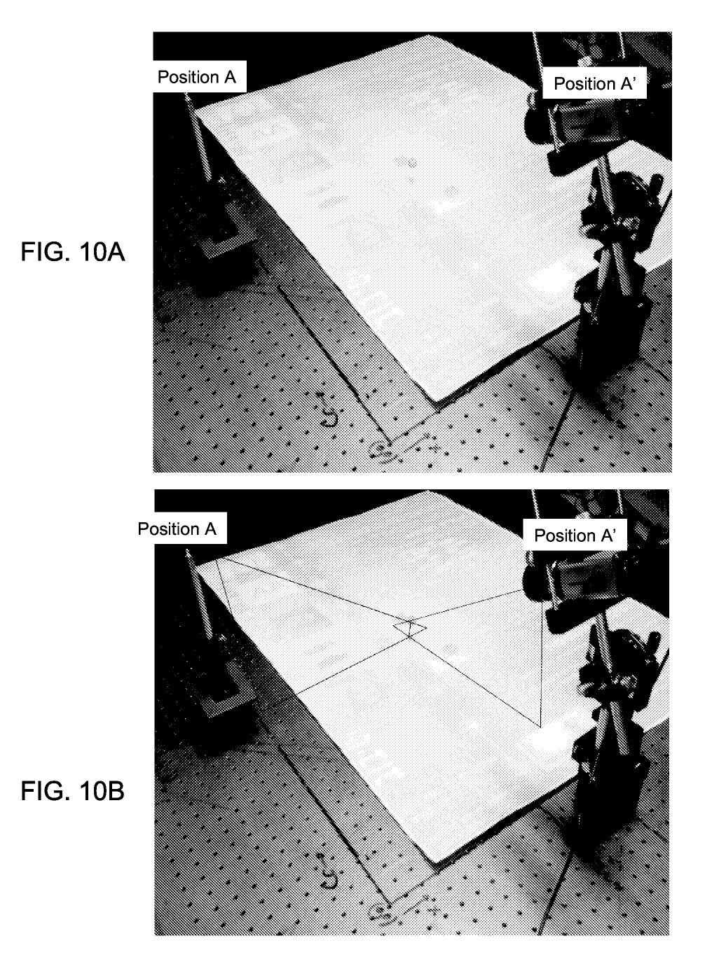

In the third experiment a cube, 15×15×15 mm³ in size, was positioned at about 30 mm above the ground plane for the entire experiment as shown in FIGS. 10A and 10B. Distance measurements and calibration of the reference images was performed manually.

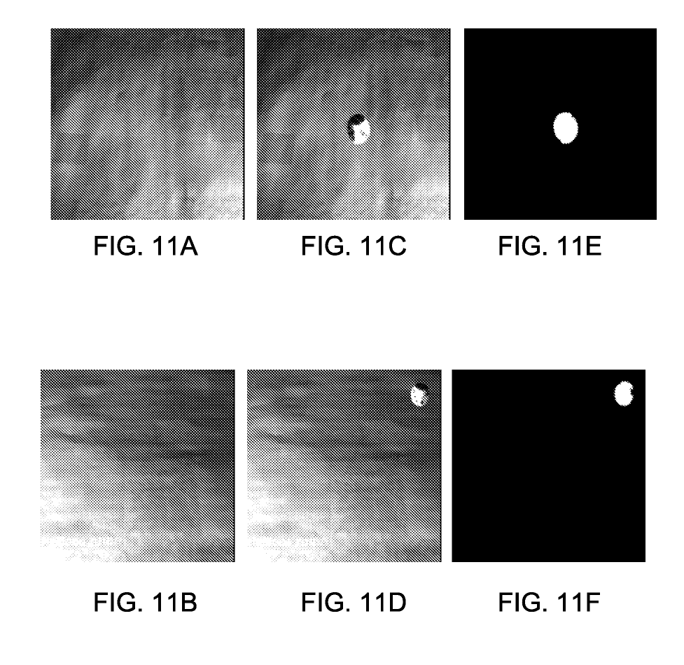

FIGS. 11A-F show the procedure used in the third experiment. FIGS. 11A, 11C and 11E correspond to viewpoint A, and FIGS. 11B, 11D and 11F correspond to viewpoint A′. FIGS. 11A and 11B show the background intensity reference images, FIGS. 11C and 11D show the input images with the object, and FIGS. 11E and 11F show the inter-frame subtraction results after segmentation.

Two projections of the cube were acquired by the digital camera from two different positions, position A and position A′ (see also FIG. 4A). The locations of the points A, A′, C and C′, in real-world coordinates and in cm units, with respect to the origin O, were as follows: A(x=0,y=43,z=30), A′(x=25,y=0,z=30), C(x=0,y=43,z=0) and C′(x=25,y=0,z=0). The center of mass of the occlusions patterns on the ground plane XOY of the cube from two perspectives, were estimated in real-world coordinates with respect to the origin as: B(x=37,y=43,z=0) and B′(x=34,y=48.5,z=0).

Based on these points, lines BC and B′C′ were represented according to the following relations: BC:Y=43 and B′C′:Y=5.4X−135.

The intersection point of the two lines, BC and B′C′, was calculated as D(x=33,y=43,z=0). EQ. 1, was then used for estimating the point P top be P(x=33,y=43,z=3.2).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of extracting three-dimensional information from an image, of a scene comprising:
comparing the image with a reference image associated with a reference depth map, so as to identify an occluded region in the scene;
analyzing an extent of said occluded region; and
based on said extent, extracting at least one of: a three-dimensional size and a three-dimensional location of an object occluding said occluded region.

2. The method according to claim 1, further comprising receiving information pertaining to the height of said object, wherein said extraction of said three-dimensional location utilizes a single viewpoint vector and is based on said height.

3. The method according to claim 1, comprising receiving a plurality of images and a plurality of reference images, respectively corresponding to a plurality of viewpoints of the same scene, wherein said comparison and said extent analysis is performed separately for each image, and wherein said extraction is based on relations between said extents.

4. The method according to claim 1, further comprising receiving information pertaining to the height of said object, wherein said extraction of said three-dimensional location is also based on said height.

5-7. (canceled)

8. The method according to claim 1, wherein the image is a video stream defined over a plurality of frames, and wherein said comparison, said analysis and said extraction are performed separately for each of at least some of said frames.

9. (canceled)

10. The method according to claim 1, further comprising segmenting the image, wherein said identification of said occluded region is based, at least in part, on said segmentation.

11-13. (canceled)

14. The method according to claim 1, further comprising associating said reference image with said reference depth map.

15. (canceled)

16. A method of three-dimensional tracking, comprising:
acquiring at least one video stream defined over a plurality of frames from a scene including therein a moving object; and
for each of at least some of said frames, executing the method according to claim 1 so as to extract three-dimensional location of said object, thereby providing a set of locations; and
using said set of locations for tracking the object.

17. The method of claim 16, further comprising predicting future motion of said object based on said tracking.

18. The method of claim 16, further comprising identifying or predicting abrupt change of altitude during said motion of the object, and issuing an alert responsively to said identification.

19. (canceled)

20. The method of claim 16, further comprising adjusting artificial environmental conditions based on said tracking.

21. The method of claim 16, further comprising identifying or predicting a change of posture of the object, and issuing an alert responsively to said identification.

22. (canceled)

23. The method according to claim 16, wherein the scene includes a plurality of objects, wherein said tracking is executed for each of at least some of said plurality of objects.

24-30. (canceled)

31. A computer software product, comprising a computer-readable medium in which program instructions are stored, which instructions, when read by a computer, cause the computer to receive an image and a reference image, and to execute the method according to claim 1.

32. A system for extracting three-dimensional information, comprising:
at least one image capturing system; and
a data processor configured for receiving at least one image of a scene from said at least one image capturing system, accessing at least one recorded reference image associated with a reference depth map, comparing said at least one image with said at least one reference image to identify an occluded region in the scene, analyzing an extent of said occluded region, and extracting at least one of: a three-dimensional size and a three-dimensional location of an object occluding said occluded region, based on said extent.

33. (canceled)

34. The system according to claim 32, wherein said at least one image capturing system is mounted indoor, and wherein said data processor is configured for transmitting information pertaining to said location and/or size via a hotspot access point.

35-36. (canceled)

37. A method of monitoring, comprising:
analyzing a video stream of a subject so as to identify a posture of said subject;
comparing said posture with a database of postures which are specific to said subject;
based on said comparison, determining the likelihood that the subject is at risk of falling; and
issuing an alert if said likelihood is above a predetermined threshold.

38. (canceled)

39. The method of claim 37, further comprising:
communicating with at least one wearable risk monitoring device;
determining whether said device is worn and/or being activate; and
issuing an alert, if said device is not worn or not activate.

40. A method of identifying a subject, comprising:
analyzing a video stream of a scene having a plurality of subjects therein so as to extract three-dimensional information pertaining to locations, shapes and sizes of the subjects;
dynamically receiving from a cellular positioning system subject-identification codes for uniquely identifying the subjects at said scene;
monitoring changes in said three-dimensional locations, so as relate, for at least one subject in the scene, a subject-identification code to a three-dimensional shape and size; and
making a record of said relation.

41. A visual communication system, comprising:
at least one access point or beacon, configured for broadcasting data over a communication region;
an arrangement of imaging devices deployed over said communication region; and
a data processor configured for receiving images from said imaging devices, determining three-dimensional information pertaining to individuals in said images, and broadcasting said three-dimensional information using said at least one access point or beacon such that at least one individual in said region receives both a location and visualization of at least one tracked individual in said region.
